(19) United States
(12) Patent Application Publication
(10) Pub. No.: US 2026/0229216 A1
(43) Pub. Date: Aug. 6, 2026

(54) Device State Aware Dynamic Automatic Speech Recognition Optimization

(71) Applicant: Google LLC, Mountain View, CA (US)

(72) Inventors: Pu-sen Chao, Los Altos, CA (US); Petar Stanisa Aleksic, Jersey City, NJ (US); Meysam Bastani, New York, NY (US); Haozhen Wu, Long Island City, NY (US)

(73) Assignee: Google LLC, Mountain View, CA (US)

(21) Appl. No.: 19/042,954

(22) Filed: Jan. 31, 2025

(51) Int. Cl. G10L 13/027; G10L 13/04

(52) U.S. Cl. CPC G10L 13/027; G10L 13/04

(57) ABSTRACT

A method includes receiving a TTS end event indicating that audible output of first TTS audio from a user device is finished. Based on receiving the TTS end event, the method also includes instructing an ASR system to use a first level of ASR processing for performing speech recognition. As a user speaks a natural language query that solicits a second response from a LLM-powered assistant, the method includes performing, by the ASR system, using the first level of ASR processing, speech recognition on the audio data to generate a speech recognition result and processing, by the LLM-powered assistant, the speech recognition result to generate the second response. Based on receiving a TTS start event indicating that second TTS audio is about to be audibly output from the user device, the method includes instructing the ASR system to use a second level of ASR processing.

### TECHNICAL FIELD

This disclosure relates to device state aware dynamic automatic speech recognition optimization.

### BACKGROUND

Automatic speech recognition (ASR) systems are an increasingly used technology. Modern ASR systems focus on providing not only high quality (e.g., a low word error rate), but also low latency (e.g., a short delay between a user speaking and a transcription or response appearing) speech recognition for spoken utterances. For example, when using a device that implements an ASR system, there is often an expectation that the ASR system decodes utterances in a streaming fashion that corresponds to real-time or even faster than real-time

ASR systems may be optimized for different use cases, such as one-shot voice search and longform keyboard dictation, but the optimization is typically static throughout speech sessions. ASR and endpointing systems are not perfect, and can make incorrect endpointing decisions too early, resulting in a user's speech being cutoff before the user is finished speaking.

### SUMMARY

One aspect of the disclosure provides a computer-implemented method for optimizing speech recognition during a voice-based conversation by dynamically tuning speech recognition. The computer-implemented method executes on data processing hardware to perform operations that include receiving a text-to-speech (TTS) end event indicating that audible output of first TTS audio from a user device associated with a user is finished. Here, the first TTS audio characterizes a first response generated by a large language model (LLM)-powered assistant that is directed toward the user during a voice-based conversation between the user and the LLM-powered assistant. The operations also include based on receiving the TTS end event, instructing an automated speech recognition (ASR) system to use a first level of ASR processing for performing speech recognition on anticipated user speech. As the user speaks a natural language query that solicits a second response from the LLM-powered assistant during the voice-based conversation the operations also include receiving an audio data characterizing the natural language query and performing, by the ASR system, using the first level of ASR processing, speech recognition on the audio data to generate a speech recognition result for the natural language query. Here, the audio data is captured by the microphone in communication with the user device. The operations also include processing, by the LLM-powered assistant, the speech recognition result for the natural language query to generate the second response solicited by the natural language query spoken by the user. The operations also include receiving a TTS start event indicating that second TTS audio is about to be audibly output from the user device. Here, the second TTS audio characterizes the second response generated by the LLM-powered assistant. The operations also include, based on receiving the TTS start event, instructing the ASR system to use a second level of ASR processing for performing speech recognition of any user speech captured by the microphone while the second TTS audio is being audibly output from the user device. Here, the second level of ASR processing is different than the first level of ASR processing.

Implementations of the disclosure may include one or more of the following optional features. In some implementations, while the LLM-powered assistant processes the speech recognition result for the natural language query to generate the second response and until the TTS start event is received, the ASR system uses the first level of ASR processing for performing speech recognition on any additional user speech captured by the microphone. In some examples, the operations further include obtaining, from the LLM-powered assistant, a conversation history of the voice-based conversation and processing the conversation history to determine a current context. Here, instructing the ASR system to use the first level of ASR processing further includes instructing the ASR system to bias speech recognition results of the anticipated user speech toward a particular vocabulary related to the current context. In some implementations, the operations further include processing a textual representation of the second response generated by the LLM-powered assistant to determine an expectation that the anticipated user speech will include a short follow-up query related to the first response. Here, instructing the ASR system to use the first level of ASR processing further includes optimizing the ASR system for recognition of the short follow-up query in the anticipated user speech.

In some examples, the first level of ASR processing includes a greater amount of speech recognition sensitivity when performing speech recognition than the second level of ASR processing. In some implementations, receiving the TTS end event includes receiving the TTS end event from an operating system of the user device. In some examples, receiving the TTS end event includes receiving the TTS end event from an acoustic echo cancellation (AEC) system executing on the user device, the AEC system configured to run speech detection on a loopback audio channel and send the TTS end event responsive to the speech detection ceasing to detect the first TTS audio on the loopback audio channel.

In some examples, the operations further include processing, using an endpointer model of the ASR system, the audio data to determine that a duration of silence detected in the audio data satisfies an end of utterance (EOU) duration threshold and based on determining that the duration of the silence detected in the audio data satisfies the EOU duration threshold, instructing the LLM-powered assistant to commence processing the speech recognition result for the natural language query. In these examples, the audio data characterizing the natural language query may include prefix audio data characterizing a prefix portion of the natural language query and the speech recognition result for the natural language query may include a prefix speech recognition result for the prefix portion of the natural language query. Here, the operations further include, after generating the prefix speech recognition result for the prefix portion of the natural language query and before receiving the TTS start event receiving suffix audio data characterizing a suffix portion of the natural language query, the suffix audio data captured by the microphone in communication with the user device and performing, by the ASR system, using the first level of ASR processing, speech recognition on the suffix audio data to generate a suffix speech recognition result for the suffix portion of the natural language query. Here, processing the speech recognition result for the natural language query to generate the second response includes processing, by the LLM-powered assistant, the prefix speech recognition result for the prefix portion of the natural language query and the suffix speech recognition result for the suffix portion of the natural language query to generate the second response solicited by the natural language query spoken by the user. In these implementations, the operations further may further include increasing a duration of the EOU duration threshold based on receiving the suffix audio data characterizing the suffix portion of the natural language query.

Another aspect of the disclosure provides a system that includes data processing hardware and memory hardware in communication with the data processing hardware and storing instructions that when executed on the data processing hardware causes the data processing hardware to perform operations that include receiving a text-to-speech (TTS) end event indicating that audible output of first TTS audio from a user device associated with a user is finished. Here, the first TTS audio characterizes a first response generated by a large language model (LLM)-powered assistant that is directed toward the user during a voice-based conversation between the user and the LLM-powered assistant. The operations also include based on receiving the TTS end event, instructing an automated speech recognition (ASR) system to use a first level of ASR processing for performing speech recognition on anticipated user speech. As the user speaks a natural language query that solicits a second response from the LLM-powered assistant during the voice-based conversation the operations also include receiving an audio data characterizing the natural language query and performing, by the ASR system, using the first level of ASR processing, speech recognition on the audio data to generate a speech recognition result for the natural language query. Here, the audio data is captured by the microphone in communication with the user device. The operations also include processing, by the LLM-powered assistant, the speech recognition result for the natural language query to generate the second response solicited by the natural language query spoken by the user. The operations also include receiving a TTS start event indicating that second TTS audio is about to be audibly output from the user device. Here, the second TTS audio characterizes the second response generated by the LLM-powered assistant. The operations also include, based on receiving the TTS start event, instructing the ASR system to use a second level of ASR processing for performing speech recognition of any user speech captured by the microphone while the second TTS audio is being audibly output from the user device. Here, the second level of ASR processing is different than the first level of ASR processing.

This aspect of the disclosure may include one or more of the following optional features. In some implementations, while the LLM-powered assistant processes the speech recognition result for the natural language query to generate the second response and until the TTS start event is received, the ASR system uses the first level of ASR processing for performing speech recognition on any additional user speech captured by the microphone. In some examples, the operations further include obtaining, from the LLM-powered assistant, a conversation history of the voice-based conversation and processing the conversation history to determine a current context. Here, instructing the ASR system to use the first level of ASR processing further includes instructing the ASR system to bias speech recognition results of the anticipated user speech toward a particular vocabulary related to the current context. In some implementations, the operations further include processing a textual representation of the second response generated by the LLM-powered assistant to determine an expectation that the anticipated user speech will include a short follow-up query related to the first response. Here, instructing the ASR system to use the first level of ASR processing further includes optimizing the ASR system for recognition of the short follow-up query in the anticipated user speech.

In some examples, the first level of ASR processing includes a greater amount of speech recognition sensitivity when performing speech recognition than the second level of ASR processing. In some implementations, receiving the TTS end event includes receiving the TTS end event from an operating system of the user device. In some examples, receiving the TTS end event includes receiving the TTS end event from an acoustic echo cancellation (AEC) system executing on the user device, the AEC system configured to run speech detection on a loopback audio channel and send the TTS end event responsive to the speech detection ceasing to detect the first TTS audio on the loopback audio channel.

In some examples, the operations further include processing, using an endpointer model of the ASR system, the audio data to determine that a duration of silence detected in the audio data satisfies an end of utterance (EOU) duration threshold and based on determining that the duration of the silence detected in the audio data satisfies the EOU duration threshold, instructing the LLM-powered assistant to commence processing the speech recognition result for the natural language query. In these examples, the audio data characterizing the natural language query may include prefix audio data characterizing a prefix portion of the natural language query and the speech recognition result for the natural language query may include a prefix speech recognition result for the prefix portion of the natural language query. Here, the operations further include, after generating the prefix speech recognition result for the prefix portion of the natural language query and before receiving the TTS start event receiving suffix audio data characterizing a suffix portion of the natural language query, the suffix audio data captured by the microphone in communication with the user device and performing, by the ASR system, using the first level of ASR processing, speech recognition on the suffix audio data to generate a suffix speech recognition result for the suffix portion of the natural language query. Here, processing the speech recognition result for the natural language query to generate the second response includes processing, by the LLM-powered assistant, the prefix speech recognition result for the prefix portion of the natural language query and the suffix speech recognition result for the suffix portion of the natural language query to generate the second response solicited by the natural language query spoken by the user. In these implementations, the operations further may further include increasing a duration of the EOU duration threshold based on receiving the suffix audio data characterizing the suffix portion of the natural language query.

The details of one or more implementations of the disclosure are set forth in the accompanying drawings and the description below. Other aspects, features, and advantages will be apparent from the description and drawings, and from the claims.

### DESCRIPTION OF DRAWINGS

FIG. 1 is a schematic view of a system for optimizing speech recognition during a voice-based conversation between a user and a large language model (LLM)-powered assistant.

FIG. 2 is a schematic view of an example speech recognition system implementing a speech recognition model and an endpointer model for joint speech recognition and endpointing tasks.

FIG. 3 is a schematic view of example dialog sessions for a voice-based conversation between the user and the LLM-powered assistant.

FIG. 4 includes a flowchart of an example arrangement of operations for a computer-implemented of optimizing speech recognition during a voice-based conversation between the user and the LLM-powered assistant.

FIG. 5 is a schematic view of an example computing device that may be used to implement the systems and methods described herein.

Like reference symbols in the various drawings indicate like elements.

### DETAILED DESCRIPTION

Humans may engage in human-to-computer dialogs with interactive software applications referred to as “chatbots,” “voice bots”, “automated assistants”, “interactive personal assistants,” “intelligent personal assistants,” “conversational agents,” etc. via a variety of computing devices. As one example, these chatbots may correspond to a machine learning model or a combination of different machine learning models, and may be utilized to perform various tasks on behalf of users.

Chatbots adopting Large language models (LLMs) are currently opening up a wide range of applications due to their powerful understanding and generation capabilities which can operate over text, image, and/or audio inputs. These models are also being extended with actuation capabilities via integration mechanisms with various service providers.

Automatic speech recognition (ASR) systems focus on providing not only high quality (e.g., a low word error rate), but also low latency (e.g., a short delay between a user speaking and a transcription or response appearing) speech recognition for spoken utterances. For example, when using a device that implements an ASR system, there is often an expectation that the ASR system decodes utterances in a streaming fashion that corresponds to real-time or even faster than real-time. Conventional speech recognition models rely on a separate, distinct, and separately trained endpoint model for performing endpointing. Endpointing includes voice activity detection (VAD) and end-of-query (EOQ) detection. VAD classifies each input audio frame according to whether it contains speech or silence. VAD classification can be used for “frame filtering” whereby non-speech frames are discarded. EOQ detection classifies each input audio frame according to predict whether or not an ongoing utterance has ended or contains an intermediate period of silence. For short-query tasks, such for digital assistant or interactive voice response applications, EOQ detection predicts when a user is done speaking, such that the speech recognition model can complete or finalize a transcription of a query and timely generate a response. For short-query tasks, high-quality EOQ detection is critical to reducing speech recognition latency, because a response to a query is typically not generated until the speech recognition model finalizes a transcription. For voice recognition systems, user-perceived latency (UPL) is a very important factor in user satisfaction.

Conversational applications (e.g., digital assistants, chatbots, voice-controlled applications, etc.) leveraging large language models (LLMs) have become more popular in recent years. Recently, the use of LLMs in conversational applications have been adapted to accept speech from a user that solicits a response from the LLM, and the conversational application in turn can provide the response generated by the LLM for audible output from a user device. For instance, the user device can use a microphone to capture a natural language utterance spoken by the user, an ASR model can convert the spoken natural language utterance into text, the LLM (or other natural language understanding module) extracts the user's intent from the text and determines a textual response based on the user's intent, and a text-to-speech (TTS) system converts the textual response into synthesized speech for audible output from the user device. In some scenarios, the ASR model includes an audio encoder that first encodes audio data characterizing the spoken input and a decoder that decodes the encoded audio data into text to form the transcription. In other scenarios, the ASR model includes the audio encoder and leverages the LLM as a speech decoder for decoding the encoded audio data into text to form the transcription. In these scenarios, the transcription decoded by the LLM can be input back to the LLM to generate the response.

Ideally, when conversing with a conversational application, a user should be able to communicate as if the user were talking to another person, via spoken queries/prompts directed toward their voice-enabled device running the conversational application. In practice, however, it is challenging for a device to always be responsive to these spoken queries/prompts since unintended background noise and speech can be captured by the voice-enabled device. Moreover, while a microphone of the voice-enabled device can be kept open for some predefined amount of time immediately after an interaction to permit the microphone to capture follow-up queries/prompts spoken by the user in a natural way, there are certain trade-offs for how long the microphone should be kept open upon immediately following an interaction. For instance, leaving a microphone open for too long can increase a likelihood of capturing unintended speech in an environment of the voice-enabled device. While, on the other hand, closing the microphone too soon creates a bad user experience since a user is required to re-initiate a conversation via a barge-in which may be inconvenient and detract from the user's experience with conversational assistant.

Implementations herein are directed toward optimizing speech recognition during a voice-based conversation between a user and a LLM-powered assistant by dynamically tuning speech recognition to opportunistically apply biasing based on context of the voice-based conversation and reduce speech recognition sensitivity when the conversational assistant is speaking. As will become apparent, by optimizing speech recognition using the techniques disclosed herein, a microphone of a user device associated with the user can remain open throughout a voice-based conversation such that the user can interrupt the conversation at anytime to provide seamless low latency speech recognition without having to speak a dedicated key phrase (e.g., hotword) before the user directs speech to the conversational assistant as part of the dialog.

Implementations herein are directed towards a spoken language model and a method of executing the spoken language model. The spoken language model includes an audio encoder and a language model decoder. The audio encoder is configured to receive, as input, a sequence of speech features characterizing a spoken prompt and generate, as output, a corresponding sequence of audio encodings. The language model decoder is configured to receive, as input, the sequence of audio encodings output from the audio encoder without any intermediary cross-attention applied to the sequence of audio encodings between the audio encoder and the language model decoder and generate, as output, an output sequence of speech features characterizing a continuation of the spoken prompt.

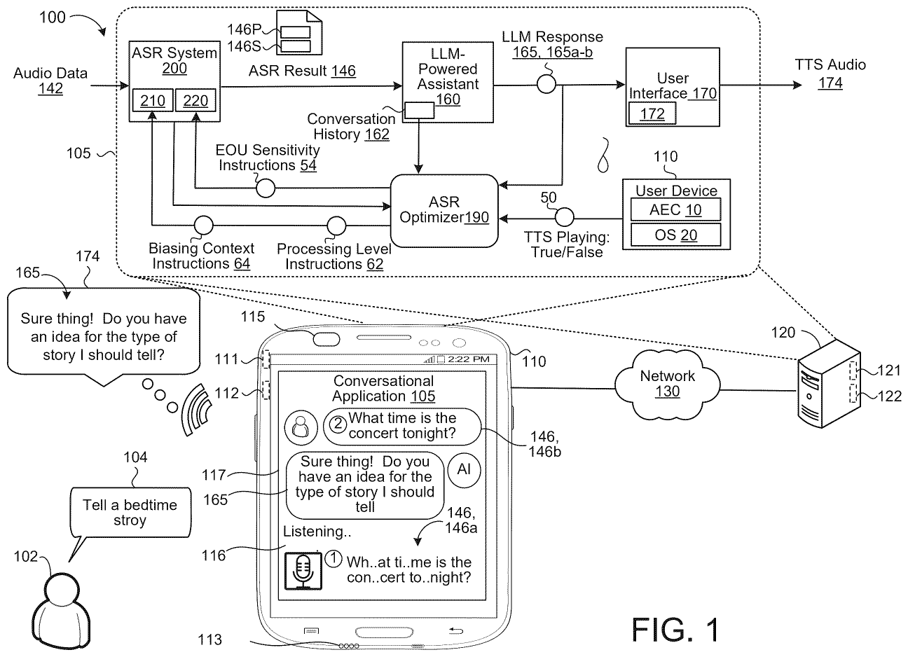

FIG. 1 illustrates an example system 100 for allowing a spoken conversation between a user 102 and an LLM-powered assistant 160. A conversational assistant application 105 may execute on a user device 110 associated with the user 102 to enable the user 102 and the LLM-powered assistant 160 to interact with one another through spoken conversation. The conversational assistant application 105 may access various components for facilitating the spoken conversation in a natural manner between the user 102 and the LLM-powered assistant 160. For instance, through the use of application programming interfaces (APIs) or other types of plug-ins, the conversation assistant application 105 may access an automated speech recognition (ASR) system 200, the LLM-powered assistant 160, an ASR optimizer 190, and a user interface 170.

During a user turn of the spoken conversation between the user 102 and the LLM-powered assistant (or simply ‘assistant’) 160, the user device 110 captures audio data 142 characterizing an utterance of a natural language query 104 spoken by the user 102 and directed toward the assistant 160 to solicit a response 165 from the assistant 160. For instance, the query 104 may specify a particular task that the user 102 would like the assistant 160 to perform, or may specify a particular question that the user 102 would like the assistant 160 to answer and the assistant 160 may generate a response 165 that answers the question. The query 104 may similarly correspond to a request for information and the assistant 160 may generate a response 165 conveying the requested information. While the term query 104 is used, the query 104 may correspond to any natural language dialog (e.g., a greeting) directed toward the LLM-powered assistant 160 during the user's turn in the spoken conversation between the user 102 and the LLM-powered assistant 160. The user 102 may speak the utterance of the query 104 in natural language and the ASR system 200 may perform speech recognition on the audio data 142 characterizing the utterance of the query 104 to generate a speech recognition result (ASR result) 146 for the query 104 spoken by the user 102. The speech recognition result 146 for the query 104 may be simply referred to as a transcription of the query 104. Thereafter, the ASR system 200 feeds the speech recognition result 146 for the query 104 to the LLM-powered assistant 160 to enable the LLM-powered assistant 160 to perform the task of generating a response 165 to the user's query 104. The conversational application 105 may display a digital assistant interface 116 on a screen 117 of the user device 110 to depict dialog turns for the conversation between the user 10 and the LLM-powered assistant 160.

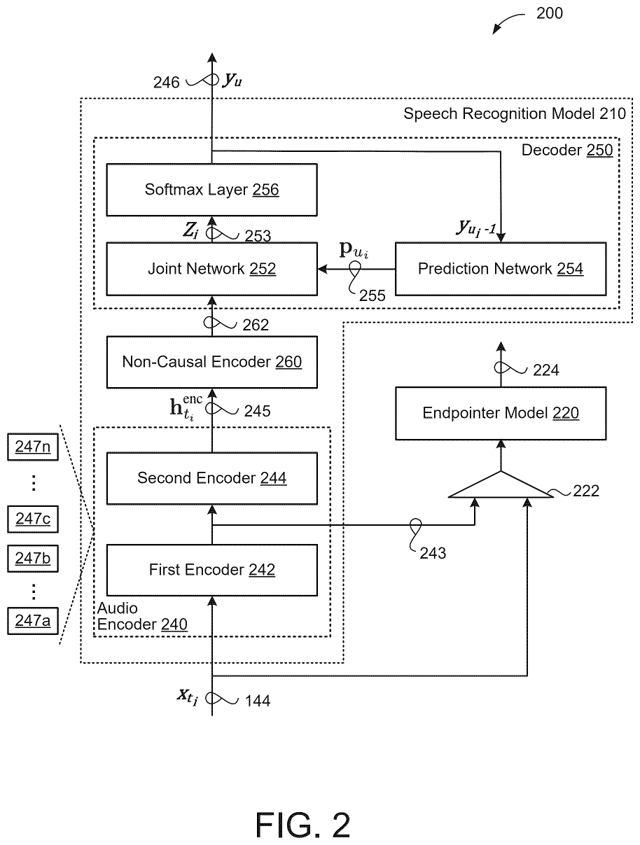

The system 100 includes the user device 110, a remote computing system 120, and a network 130. The user device 110 includes data processing hardware 111 and memory hardware 112. The user device 110 may include, or be in communication with, an audio capture device 113 (e.g., an array of one or more microphones) for converting utterances of natural language queries 104 spoken by the user 10 into corresponding audio data 102 (e.g., electrical signals or digital data). In scenarios when the user speaks a natural language query 104 captured by the microphone 113 of the user device 110, the ASR system 200 executing on the user device 110 or the remote computing system 120 may process the corresponding audio data 102 to generate a transcription (e.g., speech recognition result) 146 of the query 104. Here, the transcription conveys the textual query 104 provided as input to the assistant interface 150. The ASR system 200 may include a speech recognition model 210. The ASR system 200 may optionally implement an endpointer model 220. In some examples, the ASR system 200 includes a multi-task model that implements both the speech recognition model 210 and the endpointer model 220. The ASR system 200 may implement any number and/or type(s) of past, current, or future speech recognition systems, models and/or methods including, but not limited to, an end-to-end speech recognition model, such as streaming speech recognition models having recurrent neural network-transducer (RNN-T) model architectures, a hidden Markov model, an acoustic model, a pronunciation model, a language model, and/or a naïve Bayes classifier. In some examples, the ASR system 200 includes an audio encoder 240 (FIG. 2) and leverages the LLM-powered assistant 160 to operate as a speech decoder for decoding audio encodings 245 output by the audio encoder 240 into speech recognition results 146.

As will be described in greater detail below, the microphone 113 of the user device 110 may remain always-on or open during the conversation between the user 102 and the LLM-powered assistant 160 to permit the conversational application 105 to always accept speech spoken by the user 102, thereby providing a more natural dialog between the user 102 and the assistant 160. For instance, the user 102 may barge-in through speech directed toward the LLM-powered assistant 160 even during times when the conversational application 105 is audibly outputting, from an audio output device (e.g., speaker) 115 of the user device 110, text-to-speech (TTS) audio 174 characterizing a response 165 generated by the LLM-powered assistant 160.

The user device 110 may be any computing device capable of communicating with the remote computing system 120 through the network 130. The user device 110 includes, but is not limited to, desktop computing devices and mobile computing devices, such as laptops, tablets, smart phones, smart speakers/displays, digital assistant devices, smart appliances, internet-of-things (IoT) devices, infotainment systems, vehicle infotainment systems, and wearable computing devices (e.g., headsets, smart glasses, and/or watches).

The remote computing system 120 may be a distributed system (e.g., a cloud computing environment) having scalable elastic resources. The resources include computing resources 121 (e.g., data processing hardware) and/or storage resources 122 (e.g., memory hardware). Additionally or alternatively, the remote computing system 120 may be a centralized system. The network 130 may be wired, wireless, or a combination thereof, and may include private networks and/or public networks, such as the Internet.

With continued reference to FIG. 1, the components leveraged by the conversational assistant application 105 may execute on the data processing hardware 111 of the user device 110 or on the data processing hardware 121 of the remote computing system 120. In some implementations, the components leveraged by the conversational assistant application 105 executes on both the data processing hardware 111 of the user device 110 and the data processing hardware 121 of the remote computing system 120. For instance, one or more components of the conversational assistant application 105 may execute on the data processing hardware 111 of the user device 110 while one or more other components of the conversational assistant application 105 may execute on the remote computing system 120.

The LLM-powered assistant 160 assistant may power the conversational assistant application 105 to function as a personal chat bot capable of having dialog conversations with the user 102 in natural language and performing tasks/actions on the user's behalf. In some examples, the LLM-powered assistant 160 includes an instance of Gemini, LaMDA, BERT, Meena, ChatGPT, or any other previously trained LLM. These previously trained LLMs have been previously trained on enormous amounts of diverse data and are capable of engaging in corresponding conversations with users in a natural and intuitive manner. However, these LLMs have a plurality of machine learning (ML) layers and hundreds of millions to hundreds of billions of ML parameters.

The conversational assistant application 105 is configured to provide, for output from the user device 110, the response 165 generated by the LLM-powered assistant 160. Here, the user interface 170 may audibly output, from an audio output device (e.g., acoustic speaker) 115, text-to-speech (TTS) audio 174 that characterize the response 165 as synthesized speech. For instance, the user interface 170 may include a text-to-speech (TTS) system 172 that converts a textual representation of the response 165 into TTS audio 174 conveying the response 165 as synthesized speech. Additionally or alternatively, the conversational assistant application 105 may instruct the user interface 170 to display, on the screen 117 in communication with the user device 110, text representing the response 165. In the example shown, the user speaks the natural query 104 of “Tell a bedtime story” and the LLM-powered assistant 160 generates the response 165 of “Sure thing! Do you have an idea for the type of story I should tell?”, which may be audibly output as TTS audio 174 and/or displayed in text on the screen 117. Notably, the user interface 170 may display a conversational history 162 of queries 104 and responses 165 during the spoken conversation between the user 102 and the assistant 160. The LLM-powered assistant 160 may maintain the conversation history 162 for use as context for generating responses 165 and may provide the conversation history 162 to the ASR optimizer 190 for providing biasing context instructions 64 to the ASR model 210.

Continuing with the example in FIG. 1, assume that prior to the user's turn in the conversation where the user spoke the query 104 of “Tell a bedtime story”, the LLM-powered assistant 160 just finished a turn in the conversation where the LLM-powered assistant 160 audibly output, from the user device 110, TTS audio directed toward the user 10 during the voice-based conversation. From here, the ASR optimizer 190 receives a TTS event signal 50 that includes a TTS end event indicating that the audible output of the TTS audio from the user device for the previous turn for the LLM-powered assistant 160 is finished. The TTS event signal 50 may include a binary value of ‘true’ or ‘false’, wherein ‘true’ indicates a TTS start event indicating that audible output of TTS audio has commenced while ‘false’ indicates the TTS end event indicating that the audible output of the TTS audio has finished. In the example shown, the ASR optimizer 190 receives the TTS event signal 50 from the user device 110. In some examples, the ASR optimizer 190 receives the TTS event signal 50 from an operating system (OS) 20 of the user device that has knowledge of whether or not TTS audio is being audibly output from the user device 110. In other examples, the ASR optimizer 190 receives the TTS event signal 50 from an acoustic echo cancellation (AEC) system 10 executing on the user device 110. The AEC system 10 is configured to run speech detection on a loopback audio channel and send the TTS event signal 50 including the TTS end event responsive to the speech detection ceasing to detect TTS audio 174 on the loopback audio channel. Similarly, the AEC system 10 may send the TTS event signal 50 including the TTS start event responsive to the speech detection detecting TTS audio 174 on the loopback channel.

Based on receiving the TTS event signal 50 including the TTS end event, the ASR optimizer 190 provides processing level instructions 62 to the speech recognition model 210 that instruct the speech recognition model 210 of the ASR system 200 to use a first level of ASR processing for performing speech recognition on anticipated user speech for the user's turn. At the same time, the TTS end event causes the conversational assistant application 105 to commence a new dialog session for the user's turn. Accordingly, during the new dialog session as the user speaks the natural language query 104 of “Tell a bedtime story” that solicits a response 165 from the LLM-powered assistant 160 during the voice-based conversation, the speech recognition model 210 receives audio data 142 characterizing the natural language query 104, wherein the audio data is captured by the microphone 113 in communication with the user device 110. Thereafter, the ASR model 210 performs, using the first level of ASR processing, speech recognition on the audio data 142 to generate a speech recognition result 146 for the natural language query 104. The speech recognition result 146 includes a text-based transcription of the spoken query 104.

In some implementations, the ASR optimizer 190 receives the conversation history 162 of the voice-based conversation from the LLM-powered assistant 160 and processes the conversation history 162 to identify a current context. Based on the current context, the ASR optimizer 190 may provide biasing context instructions 64 to the speech recognition model 210 of the ASR system 200 that instructs the speech recognition model 210 to bias speech recognition results of the anticipated user speech toward a particular vocabulary related to the current context. For instance, the particular vocabulary could include a set of terms related to the current context, whereby the instructions 64 cause the speech recognition model 210 to bias recognition toward the set of terms.

The first level of ASR processing may include the ASR model 210 applying a maximum amount of speech recognition sensitivity when performing speech recognition on audio data. A second level of ASR processing may include the ASR model 210 reducing the amount of speech recognition sensitivity from the first level of ASR processing when performing speech recognition on the audio data. The speech recognition sensitivity may be adjusted by adjusting a value of confidence threshold for determining a confidence of the ASR model 210 recognizing output tokens in audio data. For instance, the ASR model 210 may apply the first level of ASR processing by setting the confidence threshold to lower value then the value of the confidence threshold when the ASR model 210 is applying the second level of ASR processing. Here, a lower value of the confidence threshold correlates to increased speech recognition sensitivity by the ASR model 210 in recognizing speech. In the instant case, since the TTS end event indicates the previous turn of the LLM-powered assistant 160 has finished and the new dialog session for the user's turn has commenced, instructing the ASR model 210 to use the first level of ASR processing will increase the accuracy of recognizing the anticipated speech (e.g., the natural language query 104 of “Tell me a bedtime story”) to be spoken by the user 102.

In some examples, the first level of ASR processing includes the ASR model 210 performing a greater number of ASR processing steps over the audio data than the number of ASR processing steps the ASR model 210 performs when using the second level of ASR processing. For instance, the first level of ASR processing may include the ASR model 210 using two-pass ASR processing where initial recognition results are generated during a first pass and then attention and/or rescoring is applied during a second pass, whereby the second level of Asr processing only generates 1-pass speech recognition without rescoring or attention. Additionally or alternatively, the first level of ASR processing may run bidirectionally and the second level of ASR processing may run the ASR model 210 unidirectionally such that less ASR processing steps are performed when the ASR model 210 is run unidirectionally compared to running bidirectionally.

In some additionally examples, the first level of ASR processing includes the ASR model 210 adjusting beam search parameters so a decoding space of the ASR model 210 is greater than the decoding space of the ASR model 210 when using the second level of ASR processing. For instance, the by increasing the decoding space, the first level of ASR processing can enable the ASR model 210 to consider a greater number of candidate recognition results than the number of candidate recognition results considered by the Asr model 210 when using the second level of ASR processing. Notably, by constraining the Asr model 210 to consider less candidate recognition results (e.g., a 2-best list) when using the second level of ASR processing, the ASR model 210 is optimized for only recognizing terms that the user may speak during barge-in events when the LLM-powered assistant 210 is serving a response to the user, while at the same time, terms recognized in background audio or noise will not be recognized and ignored.

In some additional examples, the first level of ASR processing includes the ASR system 200 using a first ASR model (e.g., streaming) model for generating initial speech recognition results during a first pass followed by a second ASR model (non-streaming) for generating final speech recognition results during a second pass. In this scenario, the second ASR model may operate as a rescoring model of the first pass. In some scenarios, the first ASR model may execute on the user device 110 and the second ASR model may execute on the remote system. In these examples, the second level of ASR processing includes the ASR system 200 using only the first model for generating speech recognition results. Alternatively, the first level of ASR processing may include the ASR system 200 using the first ASR model with increased sensitivity by setting the confidence level to a first value so that the second ASR model is only triggered with speech recognition results output by the first ASR model satisfy the confidence level set to the first value. Here, the second level of ASR processing may include the ASR system 200 using the first ASR model with decreased sensitivity relative to the first level of ASR processing by setting the confidence level to a second value greater than the first value so that the second ASR model is only triggered with the speech recognition results output by the first Asr model satisfy the confidence level set to the second value.

After the ASR model 210 generates the generate the speech recognition result 146 for the natural language query 104, the ASR system 200 feeds the speech recognition result 146 to the LLM-powered assistant 160 and the LLM-powered assistant 160 processes the speech recognition result 146 for the natural language query 104 to generate the response 165 solicited by the natural language query 104. The response 165 may include a text-based response 165 of “Sure thing! Do you have an idea for the type of story I should tell?”, and the TTS system 172 may convert the text-based response 165 into corresponding TTS audio 174 characterizing the response 165 as synthesized speech. The ASR optimizer 190 receives another TTS event signal that includes the TTS start event indicating that the TTS audio is ready and about to be audibly output from the user device 110. Based on receiving the TTS start even, the ASR optimizer 190 provides processing level instructions 62 to the speech recognition model 210 that instruct the speech recognition model 210 to use the second level of ASR processing for performing speech recognition of any user speech captured by the microphone while the TTS audio 174 characterizing the response 165 (“Sure thing! Do you have an idea for the type of story I should tell?”) is being audibly output from the user device 110. At the same time, the TTS start event causes the conversational assistant application 105 to commence a new dialog session for the LLM-powered assistant 160. As mentioned previously, the second level of ASR processing may include the ASR model reducing speech recognition sensitivity since there is a reduced likelihood that the user will not be speaking during the LLM-powered assistant's 160 turn in the conversation. However, to provide natural dialog experience, the microphone remains open at all times so that the user can barge-in when the TTS audio 174 is being audibly output, however, the reduced sensitivity associated with the second level of ASR processing will prevent the ASR model 210 from recognizing background speech or other speech that is not directed toward the LLM-powered assistant 160 as part of the conversation.

In the example, the new dialog session for the LLM-powered assistant 160 will remain active and the ASR model 210 will continue to use the second level of ASR processing until a TTS event signal 50 including a TTS end event is received that indicates the audible output of the TTS audio 174 (“Sure thing! Do you have an idea for the type of story I should tell?”) is finished. Once the TTS end event is received, the ASR optimizer 190 will once again send the processing level instructions 62 to the ASR model 210 that instruct the ASR model 210 to switch back to using the first level of ASR processing. In some scenarios, the ASR optimizer 190 processes a textual representation of the response 165 to determine an expectation that the anticipated user speech will include a short follow-up query related to the response 165. For instance, the ASR optimizer 190 may process the textual representation of the response 165 of “Sure thing! Do you have an idea for the type of story I should tell?” and determine the expectation of the short follow-up query (e.g., Yes or No) based on presence of the “?” in the response 165. Accordingly, the ASR optimizer 190 may provide biasing context instructions 64 that optimize the ASR model 210 for recognition of the short follow-up query. In other examples, the response 165 may prompt the user with a list of options whereby the ASR optimizer 190 provides biasing context instructions 64 to bias the Asr model 210 toward recognizing the list of options.

In some implementations, the ASR system 200 includes the endpointer model 220. Described in greater detail below with reference to FIG. 2, the ASR system 200 may include an end-to-end multi-task model that includes the ASR model 210 and the endpointer model 220. In some scenarios, the ASR model 210 includes a first decoder for outputting speech recognition model and a second decoder corresponding to an endpointer model 220 for outputting endpointing tokens. The endpointer model 220 of the ASR system 200 is configured to process the audio data 142 characterizing the natural language query 104 to determine that a duration of silence detected in the audio data satisfies an end of utterance (EO) duration threshold. Based on based on determining that the duration of the silence detected in the audio data satisfies the BOU duration threshold, the ASR system 200 may instruct the LLM-powered assistant to commence processing the speech recognition result 146 for the natural language query 104.

Notably, while the LLM-powered assistant processes the speech recognition result 146 for the query 104 to generate the response 165 and until the TTS event signal 50 including the TTS start event is received, the ASR model 210 continues to use the first level of ASR processing for performing speech recognition on any additional user speech captured by the microphone. Thus, even though the endpointer model 220 may have detected the EOU indicating the user has finished speaking, the current dialog session for the user 102 will continue without failing to recognize any subsequent speech in the event that the EUO decision by the endpointer model 220 was erroneous. Accordingly, despite the user making a long pause after speaking the natural language query 104 of “Tell me a bed time story?” that results in an EOU decision, the user 102 may continue speaking after the long pause to provide additional speech directed toward the LLM-powered assistant 160 as part of the same current dialog session for the user. In this scenario, the audio data 142 includes prefix audio data 142a characterizing a prefix portion of the natural language query 104 of “Tell me a bedtime story” and the speech recognition result 142 includes a prefix speech recognition result 146a for the prefix portion of the natural language query. Before receiving the TTS start event, the ASR model 210 receives suffix audio data 142b characterizing a suffix portion of the natural language query 104. For instance, the suffix portion of the natural language query 104 may include the user speaking “Make it a spooky one” to specify that the user 102 would like the LLM-powered assistant 160 to generate a bedtime story that is spooky. Since no TTS start event has been received, the ASR model 210 continues to use the first level of ASR processing to perform speech recognition on the suffix audio data 142b to generate a suffix speech recognition result 146b for the suffix portion of the natural language query 104 and feeds the suffix speech recognition result 146b to the LLM-powered assistant 160. Thereafter, the LLM-powered assistant 160 processes the prefix speech recognition result 146a for the prefix portion of the natural language query (Tell me a bedtime story) and the suffix speech recognition result 146b for the suffix portion of the natural language query (Make it a spooky one) to generate the response 165 to the natural language query 165. In some examples, based on receiving the suffix audio data 142b characterizing the suffix portion of the natural language query 104 spoken by the user 102 after the EOU decision, the ASR optimizer 190 provides EOU sensitivity instructions 54 to the endpointer model 220 that instructs the endpointer model 220 to increase a duration of the EOU duration threshold. Here, one or more instances of receiving suffix audio data 142b may indicate that the user 102 speaks with long pauses in between phrases or sentences and increasing the EOU duration threshold will allow more time for the user 102 to finish speaking without getting cut off.

FIG. 2 is a schematic view of an example ASR system 200 capable of performing the multiple tasks of speech recognition, endpointing, VAD, and EOQ detection. As shown, the ASR system 200 includes and integrates together the speech recognition model 210, the endpointer model 220, and a switch connection 222 into a single multitask model. Notably, the speech recognition model 210, the endpointer model 220, and the switch connection 222 of the E2E multitask model 200 and may be jointly trained, deployed, and maintained. As described herein, the user device 110 executes the E2E multitask model 200. However, it is understood that the remote computing system 120 may also perform one or more portions, or all, of the E2E multitask model 200 in addition to, or in lieu of, the user device 110.

In the example shown, the speech recognition model 210 includes a streaming, cascaded conformer-transducer (Conf-T) architecture including an audio encoder 240, and a decoder 250. Here, the audio encoder 240 includes a cascading, causal encoder architecture having a first encoder 242 and a second encoder 244. The cascading audio encoder 240 refers to a model structure where the encoding pathway includes the two encoders 242, 244 that cascade such that the output of the first encoder 242 feeds the input of the second encoder 244 prior to decoding.

The first encoder 242 receives or obtains a sequence of d-dimensional feature vectors (e.g., audio frames 144 (FIG. 1)) x=(x₁, x₂, . . . , x_{T}), where xₜ∈ [symbol] , and encodes the sequence of audio frames 144 into corresponding latent representations 243 as outputs of a final layer of the first encoder 242. The second encoder 244 is connected in cascade to the first encoder 242, and is trained to receive the latent representations 243 as inputs, and encode the latent representations 243 into corresponding first higher-order feature representations 245 as outputs of a final layer of the second encoder 244. This first higher-order feature representation 245 is denoted as

$${h}_{1}^{enc} , … , {h}_{T}^{enc} .$$

Here, each audio frame 144 includes a 128-dim log-mel feature vector computed for a 32 millisecond window every 10 milliseconds and stacked with three previous feature vectors to produce a 512-dim audio frame 144.

In some examples, the speech recognition model 210 also includes a non-causal encoder 260 configured to receive as input the first higher order feature representations 245 and generate as output corresponding second higher-order feature representations 262 for the first higher-order feature representations 245.

In some implementations, the cascading audio encoder 240 includes a stack of a plurality (e.g., seven) of multi-head (e.g., eight headed) attention layers 247, 247a-n (e.g., conformer or transformer layers), with (i) the first encoder 242 including an initial stack of layers 247a-b (e.g., two) from the stack of the plurality of layers 247 with an attention dimension of 512, and (ii) the second encoder 244 including a time-reduction stacking layer that down samples its input by a factor of two followed by another multi-head attention layer 247c from the stack of the plurality of multi-head attention layers 247, a projection layer, and the rest of the multi-head attention layers 247d-n from the stack of the plurality of multi-head attention layers 247. Here, causal convolution and left-context attention layers may be used for each layer to strictly restrict the audio encoder 240 to use no future inputs. The first encoder 242 may be referred to as a causal encoder and the second encoder 244 may be referred to as a non-causal encoder.

The endpointer model 220 is configured to operate between a VAD mode and an EOQ detection mode. While the endpointer model 220 is operating in the VAD mode, the switch connection 222 provides input audio frames 144 to the endpointer model 220, and the endpointer model 220 performs VAD based on the audio frames 144. When the endpointer model 220 is operating in the VAD mode, which occurs prior to starting speech recognition, the speech recognition model 210 (including the shared first encoder 242) is not, or does not need to be, activated (i.e., audio frames 144 do not need to be sent to or processed by the speech recognition model 210) because the endpointer model 220 is performing VAD based on the audio frames 144. In the VAD mode, the endpointer model 220 outputs, for each audio frame 144, an endpoint label 224 that indicates whether or not the audio frame 144 includes speech. During the VAD mode, the endpointer model 220 selects each endpoint label 224 to be initial silence (i.e., silence before the start of an utterance) or speech. Here, the endpointer model E2E multitask model 200 may determine whether or not an audio frame 144 includes speech by comparing a speech present prediction probability to a pre-determined probability threshold.

When the endpointer model 220 determines that one or more audio frames 144 include speech and outputs one or more endpoint labels 224 of speech, the ASR system 200: (i) activates the speech recognition model 210 so that the speech recognition model 210 begins performing speech recognition on a sequence of audio frames 144; (ii) configures the switch connection 222 to provide latent representations 243 for the sequence of audio frames 144 generated by a shared portion of the audio encoder 240 (i.e., the first encoder 242) to the endpointer model 220; and (iii) switches operation of the endpointer model 220 from the VAD mode to the BOQ detection mode. In the EOQ detection mode, the endpointer model 220 determines, for each latent representation 243, whether or not the latent representation 243 includes a final silence representing that an EOQ event has occurred or includes an intermediate silence, and outputs a corresponding endpoint label 224 of final silence or intermediate silence. Here, the endpointer model 220 selects each endpoint label 224 to be speech, intermediate silence (e.g., silence in the middle of an utterance), or final silence (e.g., after the end of an utterance). Here, the endpointer model 220 may determine whether or not an audio frame 144 includes speech by comparing a speech present prediction probability to a pre-determined probability threshold. Notably, the pre-determined probability threshold for the EOQ detection mode may be different from the pre-determined probability threshold for the VAD mode.

While the endpointer model 220 is operating in the EOQ detection mode, the switch connection 222 provides latent representations 243 output from a final layer 247b of the shared layers 247a-b (i.e., the first encoder 242) to the endpointer model 220, and the endpointer model 220 performs EOQ detection based on the latent representations 243. Thus, in the EOQ detection mode, the endpointer model 220 takes can take advantage of, or leverage, the latent representations 243 already being generated by the audio encoder 240 for speech recognition purposes to improve EOQ detection performance without increasing computational complexity. That is, because the EOQ detection mode is only active during speech recognition, during which the audio encoder 240 is active for speech recognition purposes, EOQ detection performance may be improved by being based on the latent representations 243 already being generated by the audio encoder 240 without increasing computational complexity.

In the example shown, while operating in the EOQ detection mode, the endpointer model 220 shares one or more layers 247a-b with the audio encoder 240 of the speech recognition model 210. Here, the endpointer model 220 shares the first encoder 242 with the audio encoder 240, the first encoder 242 represents an initial stack of multi-head attention layers 247a-b (e.g., conformer or transformer layers) of a stack 246 of a plurality of multi-head attention layers 247a-n that form the audio encoder 240, and the latent representations 243 are output by a final layer 247b of the initial stack of layers 247a-b of the first encoder 242. In some implementations, the endpointer model 220 and the audio encoder 240 share layers using hard parameter sharing. Notably, the speech recognition model 210 and the endpointer model 220 may be jointly trained. By integrating and jointly training the speech recognition model 210 and the endpointer model 220, VAD and EOQ detection performance is improved, as joint training forces the speech recognition model 210 and the endpointer model 220 to learn representations that generalize well across related tasks. When the endpointer model 220, while operating in the EOQ detection mode, determines that one or more latent representations 243 include a final silence and outputs an endpoint label 224 of final silence, the E2E multitask model 200: (i) switches operation of the endpointer model 220 from the EOQ detection mode to the VAD mode; (ii) configures the switch connection 222 to provide input audio frames 144 to the endpointer model 220; and (iii) disables the speech recognition model 210.

In some implementations, when the endpointer model 220, while operating in the EOQ detection mode, determines that one or more latent representations 243 include an intermediate silence and outputs an endpoint label 224 of intermediate silence, the E2E multitask model 200: (i) temporarily switches operation of the endpointer model 220 from the EOQ detection mode to the VAD mode; (ii) configures the switch connection 222 to provide input audio frames 144 to the endpointer model 220; and (iii) temporarily disables the speech recognition model 210. When speech continues (e.g., when the endpointer model 220 operating in VAD mode detects speech), the E2E multitask model 200 reverts the endpointer model 220 back to EOQ detection mode and resumes speech recognition by the speech recognition model 210. In this way, the speech recognition model 210 does not need to operate during intermediate silences. In some implementations, the endpointer model 220 includes a stack of LSTM layers followed by a fully-connected layer having a Softmax function configured to predict a probability distribution over possible endpointing labels of speech, initial silence, an intermediate silence, and final silence.

In the example shown, the decoder 250 includes an RNN-T architecture having a joint network 252, a prediction network 254, and a Softmax layer 256. The decoder 250 uses the joint network 252 to combine the first higher-order feature representation 245 and/or the second higher-order feature representation 262 with dense or hidden representations 255 output from the prediction network 254 for previous prediction outputs 257 by the Softmax layer 256 to produce prediction outputs 257. In the example shown, the decoder 250 includes the Softmax layer 256. Alternatively, the Softmax layer 256 may be implemented separately.

In the example shown, the prediction network 254 processes sequence of non-blank symbols 257 (i.e., prediction outputs) output by the final Softmax layer 256 so far, y₀, . . . , yᵤᵢ₋₁, into a dense or hidden representation pᵤ_{ᵢ} 255. In some implementations, the dense representation pᵤ_{ᵢ} 255 includes a single embedding vector. Notably, the sequence of past non-blank symbols 257 received at the prediction network 254 capture linguistic dependencies between non-blank symbols 257 predicted during the previous time steps so far to assist the joint network 252 in predicting the probability of a next output symbol or blank symbol during the current time step. To contribute to techniques for reducing the size of the prediction network 254 without sacrificing accuracy/performance of the decoder 250, the prediction network 254 may receive a limited-history sequence of non-blank symbols 257 yᵤᵢ₋ₙ, . . . , yᵤᵢ₋₁ that is limited to the N previous non-blank symbols 257 output by the final Softmax layer 256.

In the example shown, the joint network 252 combines the first higher-order feature representation 245 produced by the audio encoder 240 and/or the second higher-order feature representation 262 produced by the non-causal encoder 260, and the dense representation pᵤ_{ᵢ} 255 produced by the prediction network 254. The joint network 252 predicts a probability distribution Zᵢ=P(yᵢ|xₜ_{ᵢ}, y₀, . . . , yᵤ_{ᵢ₋₁}) 253 over the next output symbol. Stated differently, the joint network 252 generates, at each time step, a probability distribution 253 over possible speech recognition hypotheses. Here, the “possible speech recognition hypotheses” correspond to a set of output labels each representing a symbol/character in a specified natural language. For example, when the natural language is English, the set of output labels may include twenty-seven (27) symbols, e.g., one label for each of the 26-letters in the English alphabet and one label designating a space. Accordingly, the joint network 252 may output a set of values indicative of the likelihood of occurrence of each of a predetermined set of output labels. This set of values can be a vector and can indicate a probability distribution over the set of output labels. In some cases, the output labels are graphemes (e.g., individual characters, and potentially punctuation and other symbols), but the set of output labels is not so limited. For example, the set of output labels can include wordpieces and/or entire words, in addition to or instead of graphemes. The output distribution of the joint network 252 can include a posterior probability value for each of the different output labels. Thus, if there are 100 different output labels representing different graphemes or other symbols, the output Zᵢ 253 of the joint network 252 can include 100 different probability values, one for each output label. The probability distribution can then be used to select and assign scores to candidate orthographic elements (e.g., graphemes, wordpieces, and/or words) in a beam search process (e.g., by the Softmax layer 256) for determining the transcription 146.

In the example shown, the final Softmax layer 256 receives the probability distribution Zᵢ 253 and selects the output label/symbol with the highest probability to produce the transcription 146. The final Softmax layer 256 may employ any technique to select the output label/symbol with the highest probability in the distribution Zᵢ 253. In this manner, the decoder 250 does not make a conditional independence assumption, rather the prediction of each symbol yᵤ 257 is conditioned not only on the acoustics but also on the sequence of labels 257 yᵤᵢ₋ₙ, . . . , yᵤᵢ₋₁ output so far. The decoder 250 does assume an output symbol 257 is independent of future acoustic frames 144, which allows the speech recognition model 210 to be employed in a streaming fashion.

In some implementations, the prediction network 254 includes a V2 embedding look up table that includes an embedding prediction network. At each time step, the V2 embedding lookup table may receive, as input, the previous two predictions (e.g., 1-hot vectors) output by the joint network 252, compute a respective embedding d₁, d₂ for each of the previous two predictions, and provide a concatenated output [d₁, d₂] to the joint network 252. Alternatively, the prediction network 254 may include one or more conformer or transformer layers. Alternatively, the prediction network 254 may be a long short-term memory (LSTM)-based prediction network including one or more LSTM layers, each of which is followed by a projection layer as well as an embedding layer. In some implementations, the joint network 252 includes one or more neural network layers each having a plurality of hidden units, and the Softmax layer 256 is composed of a unified word piece or grapheme set that is generated using all unique word pieces or graphemes in a plurality of training data sets.

Notably, the speech recognition model 210 and the endpointer model 220 may be jointly trained on a set of training speech utterances using multitask learning. Here, each training speech utterance in the set of training speech utterances includes audio data characterizing the training speech utterance paired with a corresponding transcription of the training speech utterance, and a sequence of reference endpointing labels each including one of a reference speech label, a reference initial silence label, a reference intermediate silence label, or a reference final silence label. In some implementations, the speech recognition model 210 is trained on an ASR task using the set of training speech utterances by determining a speech recognition loss [symbol] _{ASR} based on speech recognition results predicted for the audio data by the speech recognition model 210 and the corresponding transcriptions of the training speech utterances, and training the speech recognition model 210 based on the speech recognition loss [symbol] _{ASR}. Here, the endpointer model 220 is trained on an endpointing task the set of training speech utterances by determining an endpointing loss [symbol] ₑₚ based on the sequence of reference endpointing labels and a corresponding sequence of predicted endpointing labels output by the endpointer model 220, and training the endpointer model 220 based on the endpointer loss [symbol] ₑₚ. In other implementations, the speech recognition model 210 and the endpointer model 220 are trained based on the same weighted combination loss [symbol] ₘᵤₗₜᵢ determined based on the speech recognition loss [symbol] _{ASR} and the endpointing loss [symbol] _{EP}, which may be expressed as

$${ℒ}_{multi} = λ {L}_{A S R} + ( 1 - λ ) {ℒ}_{EP} \qquad EQN ( 1 )$$

where λ∈[0,1] is a hyperparameter defining relative weights given to the speech recognition and endpointing tasks. In some examples, for each training speech utterance, the switch connection 222 randomly chooses the endpointer model 220 to receive, as input, one of the latent representations 243 output from the final layer of the initial stack of multi-head attention layers (i.e., the final layer of the first encoder 242) for the audio data characterizing the training speech utterance, or the audio data characterizing the training speech utterance.

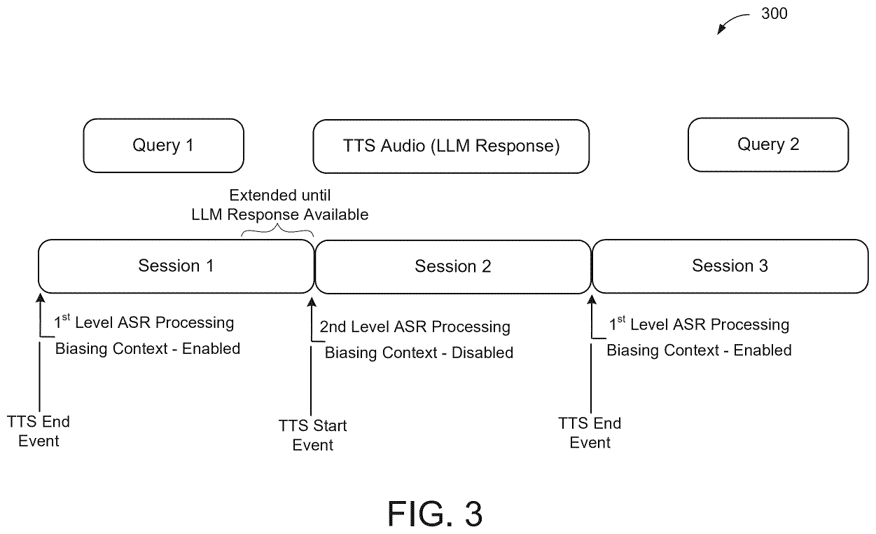

FIG. 3 provides a schematic view 300 depicting dialog sessions 1-3 during a voice-based conversation between a user 102 and an LLM-powered assistant 160. The sessions 1-3 progress with time from left to right depicted in the schematic view 300 of FIG. 3. The conversational assistant application 105 instructs session 1 to commence for a user's turn in the conversation upon receiving a TTS end event. Based on receiving the TTS end event, the ASR optimizer 190 may provide the processing level instructions 62 to the ASR system 200 that instructs the ASR system 200 to use the first level of ASR processing when performing recognition of anticipated user speech during the user's turn in session 1. The ASR optimizer 190 may additionally provide biasing processing instructions 64 that instruct the ASR system 200 toward a particular vocabulary based on a current context of the voice-based conversation. The current context may be ascertained based on a conversation history 162. During session 1, the user speaks a first natural language query (Query 1). Here, the ASR system 200 uses the first level of ASR processing to perform speech recognition on audio data 142 characterizing Query 1 to generate a speech recognition result 146 for Query 1. The ASR system 200 may detect a duration of silence in the audio data 142 satisfies the EOU threshold to indicate the user is finished speaking after Query 1. While the LLM-powered assistant 160 may commence processing the speech recognition result 146 for Query 1 to generate a response 165, the conversational assistant application 105 extends the duration of session 1 until a TTS start event is received, i.e., session 1 is extended until the response 165 is ready to be audibly output as TTS audio 174. Advantageously, the ASR model 210 will continue to use the first level of ASR processing in the event the user was not finished speaking and provides additional speech as part of Query 1 so that the additional speech is not cut-off.

The conversational assistant application 105 instructs session 2 to commence for the LLM-powered assistant's 160 turn in the conversation upon receiving a TTS start event. Here, the TTS start event indicates that the TTS audio 174 is about to be audibly output from the user device 110. In some examples, the TTS start event is received responsive to the TTS audio 174 being audibly output from the user device. Based on receiving the TTS start event, the ASR optimizer 190 may provide the processing level instructions 62 to the ASR system 200 that instructs the ASR system 200 to use the second level of ASR processing on any user speech received during the assistant's turn in session 2 while the TTS audio is being audibly output. The ASR optimizer 190 may additionally provide biasing processing instructions 64 that instruct the ASR system 200 to not provide any biasing, or may instruct the ASR system 200 to only bias toward, or recognize, terms that are typically spoken when a user barges into a conversation.

The conversation assistant 105 instructs session 3 to commence for a next user turn in the conversation upon receiving another TTS end event. As with session 1, the ASR optimizer 190 may provide the processing level instructions 62 to the ASR system 200 that instructs the ASR system 200 to use the first level of ASR processing when performing recognition of anticipated user speech during the user's turn in session 3. The ASR optimizer 190 may additionally provide biasing processing instructions 64 that instruct the ASR system 200 toward a different particular vocabulary based on a current context of the voice-based conversation that has since changed since session 1.

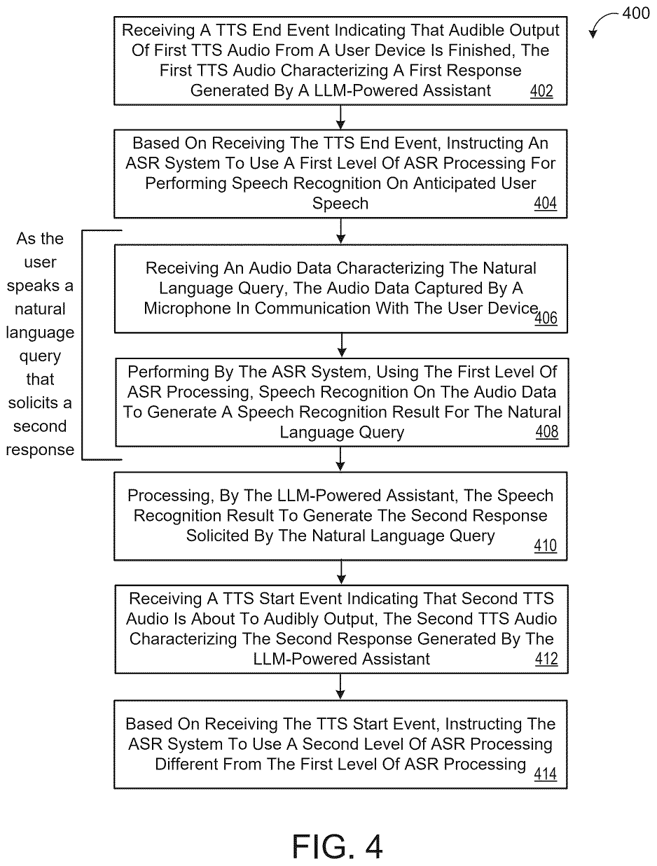

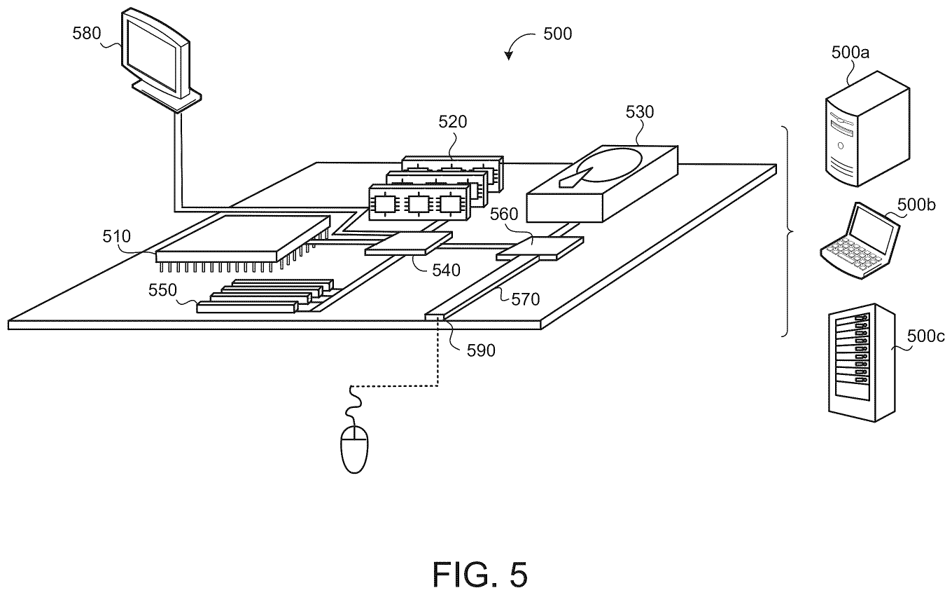

FIG. 4 includes a flowchart of an example arrangement of operations for a computer-implemented 400 of optimizing speech recognition during a voice-based conversation between a user 102 and an LLM-powered assistant 160. The method 400 may execute on data processing hardware 510 (FIG. 5) using instructions stored on memory hardware 520 (FIG. 5) that may reside on the user device 110 and/or the remote system 120 of FIG. 1 each corresponding to a computing device 500 (FIG. 5).

At operation 402, the method 400 includes receiving a text-to-speech (TTS) end event 50 indicating that audible output of first TTS audio 174 from a user device 110 associated with a user 102 is finished. Here, the first TTS audio 174 characterizes a first response 165 generated by a large language model (LLM)-powered assistant 160 that is directed toward the user 102 during a voice-based conversation between the user 102 and the LLM-powered assistant 160. At operation 404, the method 400 includes, based on receiving the TTS end event 50, instructing an automated speech recognition (ASR) system 200 to use a first level of ASR processing for performing speech recognition on anticipated user speech.

As the user 102 speaks a natural language query 104 that solicits a second response 165 from the LLM-powered assistant 160 during the voice-based conversation, the method 400 performs operations 406 and 408. At operation 406, the method 400 includes receiving an audio data 102 characterizing the natural language query 104, the audio data 102 captured by the microphone 113 in communication with the user device 110. At operation 408, the method 400 includes performing, by the ASR system 200, using the first level of ASR processing ##, speech recognition on the audio data 102 to generate a speech recognition result 146 for the natural language query 104.

At operation 410, the method 400 includes processing, by the LLM-powered assistant 160, the speech recognition result 146 for the natural language query 104 to generate the second response 165 solicited by the natural language query 104 spoken by the user 102. At operation 412, the method 400 includes receiving a TTS start event 50 indicating that second TTS audio 174 is about to be audibly output from the user device 110. Here, the second TTS audio 174 characterizes the second response 165 generated by the LLM-powered assistant 160. At operation 414, the method 400 includes, based on receiving the TTS start event 50, instructing the ASR system 200 to use a second level of ASR processing for performing speech recognition of any user speech captured by the microphone 113 while the second TTS audio 174 is being audibly output from the user device 110. Here, the second level of ASR processing is different than the first level of ASR processing.

FIG. 5 is a schematic view of an example computing device 500 that may be used to implement the systems and methods described in this document. The computing device 500 is intended to represent various forms of digital computers, such as laptops, desktops, workstations, personal digital assistants, servers, blade servers, mainframes, and other appropriate computers. The components shown here, their connections and relationships, and their functions, are meant to be exemplary only, and are not meant to limit implementations of the inventions described and/or claimed in this document.

The computing device 500 includes a processor 510, memory 520, a storage device 530, a high-speed interface/controller 540 connecting to the memory 520 and high-speed expansion ports 550, and a low speed interface/controller 560 connecting to a low speed bus 570 and a storage device 530. Each of the components 510, 520, 530, 540, 550, and 560, are interconnected using various busses, and may be mounted on a common motherboard or in other manners as appropriate. The processor 510 can process instructions for execution within the computing device 500, including instructions stored in the memory 520 or on the storage device 530 to display graphical information for a graphical user interface (GUI) on an external input/output device, such as display 580 coupled to high speed interface 540. In other implementations, multiple processors and/or multiple buses may be used, as appropriate, along with multiple memories and types of memory. Also, multiple computing devices 500 may be connected, with each device providing portions of the necessary operations (e.g., as a server bank, a group of blade servers, or a multi-processor system).

The memory 520 stores information non-transitorily within the computing device 500. The memory 520 may be a computer-readable medium, a volatile memory unit(s), or non-volatile memory unit(s). The non-transitory memory 520 may be physical devices used to store programs (e.g., sequences of instructions) or data (e.g., program state information) on a temporary or permanent basis for use by the computing device 500. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

The storage device 530 is capable of providing mass storage for the computing device 500. In some implementations, the storage device 530 is a computer-readable medium. In various different implementations, the storage device 530 may be a floppy disk device, a hard disk device, an optical disk device, or a tape device, a flash memory or other similar solid state memory device, or an array of devices, including devices in a storage area network or other configurations. In additional implementations, a computer program product is tangibly embodied in an information carrier. The computer program product contains instructions that, when executed, perform one or more methods, such as those described above. The information carrier is a computer- or machine-readable medium, such as the memory 520, the storage device 530, or memory on processor 510.

The high speed controller 540 manages bandwidth-intensive operations for the computing device 500, while the low speed controller 560 manages lower bandwidth-intensive operations. Such allocation of duties is exemplary only. In some implementations, the high-speed controller 540 is coupled to the memory 520, the display 580 (e.g., through a graphics processor or accelerator), and to the high-speed expansion ports 550, which may accept various expansion cards (not shown). In some implementations, the low-speed controller 560 is coupled to the storage device 530 and a low-speed expansion port 590. The low-speed expansion port 590, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The computing device 500 may be implemented in a number of different forms, as shown in the figure. For example, it may be implemented as a standard server 500a or multiple times in a group of such servers 500a, as a laptop computer 500b, or as part of a rack server system 500c.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

A number of implementations have been described. Nevertheless, it will be understood that various modifications may be made without departing from the spirit and scope of the disclosure. Accordingly, other implementations are within the scope of the following claims.

What is claimed is:

1. A computer-implemented method executing on data processing hardware that causes the data processing hardware to perform operations comprising:
receiving a text-to-speech (TTS) end event indicating that audible output of first TTS audio from a user device associated with a user is finished, the first TTS audio characterizing a first response generated by a large language model (LLM)-powered assistant that is directed toward the user during a voice-based conversation between the user and the LLM-powered assistant;
based on receiving the TTS end event, instructing an automated speech recognition (ASR) system to use a first level of ASR processing for performing speech recognition on anticipated user speech;
as the user speaks a natural language query that solicits a second response from the LLM-powered assistant during the voice-based conversation:
receiving an audio data characterizing the natural language query, the audio data captured by the microphone in communication with the user device; and
performing, by the ASR system, using the first level of ASR processing, speech recognition on the audio data to generate a speech recognition result for the natural language query;
processing, by the LLM-powered assistant, the speech recognition result for the natural language query to generate the second response solicited by the natural language query spoken by the user;
receiving a TTS start event indicating that second TTS audio is about to be audibly output from the user device, the second TTS audio characterizing the second response generated by the LLM-powered assistant; and
based on receiving the TTS start event, instructing the ASR system to use a second level of ASR processing for performing speech recognition of any user speech captured by the microphone while the second TTS audio is being audibly output from the user device, the second level of ASR processing different than the first level of ASR processing.

2. The method of claim 1, wherein, while the LLM-powered assistant processes the speech recognition result for the natural language query to generate the second response and until the TTS start event is received, the ASR system uses the first level of ASR processing for performing speech recognition on any additional user speech captured by the microphone.

3. The method of claim 1, wherein the operations further comprise:
obtaining, from the LLM-powered assistant, a conversation history of the voice-based conversation; and
processing the conversation history to determine a current context,
wherein instructing the ASR system to use the first level of ASR processing further comprises instructing the ASR system to bias speech recognition results of the anticipated user speech toward a particular vocabulary related to the current context.

4. The method of claim 1, wherein the operations further comprise:
processing a textual representation of the second response generated by the LLM-powered assistant to determine an expectation that the anticipated user speech will comprise a short follow-up query related to the first response,
wherein instructing the ASR system to use the first level of ASR processing further comprises optimizing the ASR system for recognition of the short follow-up query in the anticipated user speech.

5. The method of claim 1, wherein the first level of ASR processing comprises a greater amount of speech recognition sensitivity when performing speech recognition than the second level of ASR processing.

6. The method of claim 1, wherein receiving the TTS end event comprises receiving the TTS end event from an operating system of the user device.

7. The method of claim 1, wherein receiving the TTS end event comprises receiving the TTS end event from an acoustic echo cancellation (AEC) system executing on the user device, the AEC system configured to run speech detection on a loopback audio channel and send the TTS end event responsive to the speech detection ceasing to detect the first TTS audio on the loopback audio channel.

8. The method of claim 1, wherein the operations further comprise:
processing, using an endpointer model of the ASR system, the audio data to determine that a duration of silence detected in the audio data satisfies an end of utterance (BOU) duration threshold; and
based on determining that the duration of the silence detected in the audio data satisfies the EOU duration threshold, instructing the LLM-powered assistant to commence processing the speech recognition result for the natural language query.

9. The method of claim 8, wherein:
the audio data characterizing the natural language query comprises prefix audio data characterizing a prefix portion of the natural language query;
the speech recognition result for the natural language query comprises a prefix speech recognition result for the prefix portion of the natural language query; and
the operations further comprise, after generating the prefix speech recognition result for the prefix portion of the natural language query and before receiving the TTS start event:
receiving suffix audio data characterizing a suffix portion of the natural language query, the suffix audio data captured by the microphone in communication with the user device; and
performing, by the ASR system, using the first level of ASR processing, speech recognition on the suffix audio data to generate a suffix speech recognition result for the suffix portion of the natural language query,
wherein processing the speech recognition result for the natural language query to generate the second response comprises processing, by the LLM-powered assistant, the prefix speech recognition result for the prefix portion of the natural language query and the suffix speech recognition result for the suffix portion of the natural language query to generate the second response solicited by the natural language query spoken by the user.

10. The method of claim 9, wherein the operations further comprise increasing a duration of the EOU duration threshold based on receiving the suffix audio stream characterizing the suffix portion of the natural language query.

11. A system comprising:
data processing hardware; and
memory hardware in communication with the data processing hardware, the memory hardware storing instructions that when executed on the data processing hardware cause the data processing hardware to perform operations comprising:
receiving a text-to-speech (TTS) end event indicating that audible output of first TTS audio from a user device associated with a user is finished, the first TTS audio characterizing a first response generated by a large language model (LLM)-powered assistant that is directed toward the user during a voice-based conversation between the user and the LLM-powered assistant;
based on receiving the TTS end event, instructing an automated speech recognition (ASR) system to use a first level of ASR processing for performing speech recognition on anticipated user speech;
as the user speaks a natural language query that solicits a second response from the LLM-powered assistant during the voice-based conversation:
receiving an audio data characterizing the natural language query, the audio data captured by the microphone in communication with the user device; and
performing, by the ASR system, using the first level of ASR processing, speech recognition on the audio data to generate a speech recognition result for the natural language query;
processing, by the LLM-powered assistant, the speech recognition result for the natural language query to generate the second response solicited by the natural language query spoken by the user;
receiving a TTS start event indicating that second TTS audio is about to be audibly output from the user device, the second TTS audio characterizing the second response generated by the LLM-powered assistant; and
based on receiving the TTS start event, instructing the ASR system to use a second level of ASR processing for performing speech recognition of any user speech captured by the microphone while the second TTS audio is being audibly output from the user device, the second level of ASR processing different than the first level of ASR processing.

12. The system of claim 11, wherein, while the LLM-powered assistant processes the speech recognition result for the natural language query to generate the second response and until the TTS start event is received, the ASR system uses the first level of ASR processing for performing speech recognition on any additional user speech captured by the microphone.

13. The system of claim 11, wherein the operations further comprise:
obtaining, from the LLM-powered assistant, a conversation history of the voice-based conversation; and
processing the conversation history to determine a current context,
wherein instructing the ASR system to use the first level of ASR processing further comprises instructing the ASR system to bias speech recognition results of the anticipated user speech toward a particular vocabulary related to the current context.

14. The system of claim 11, wherein the operations further comprise:
processing a textual representation of the second response generated by the LLM-powered assistant to determine an expectation that the anticipated user speech will comprise a short follow-up query related to the first response,
wherein instructing the ASR system to use the first level of ASR processing further comprises optimizing the ASR system for recognition of the short follow-up query in the anticipated user speech.

15. The system of claim 11, wherein the first level of ASR processing comprises a greater amount of speech recognition sensitivity when performing speech recognition than the second level of ASR processing.

16. The system of claim 11, wherein receiving the TTS end event comprises receiving the TTS end event from an operating system of the user device.

17. The system of claim 11, wherein receiving the TTS end event comprises receiving the TTS end event from an acoustic echo cancellation (AEC) system executing on the user device, the AEC system configured to run speech detection on a loopback audio channel and send the TTS end event responsive to the speech detection ceasing to detect the first TTS audio on the loopback audio channel.

18. The system of claim 11, wherein the operations further comprise:
processing, using an endpointer model of the ASR system, the audio data to determine that a duration of silence detected in the audio data satisfies an end of utterance (EOU) duration threshold; and
based on determining that the duration of the silence detected in the audio data satisfies the EOU duration threshold, instructing the LLM-powered assistant to commence processing the speech recognition result for the natural language query.

19. The system of claim 18, wherein:
the audio data characterizing the natural language query comprises prefix audio data characterizing a prefix portion of the natural language query;
the speech recognition result for the natural language query comprises a prefix speech recognition result for the prefix portion of the natural language query; and
the operations further comprise, after generating the prefix speech recognition result for the prefix portion of the natural language query and before receiving the TTS start event:
receiving suffix audio data characterizing a suffix portion of the natural language query, the suffix audio data captured by the microphone in communication with the user device; and
performing, by the ASR system, using the first level of ASR processing, speech recognition on the suffix audio data to generate a suffix speech recognition result for the suffix portion of the natural language query,
wherein processing the speech recognition result for the natural language query to generate the second response comprises processing, by the LLM-powered assistant, the prefix speech recognition result for the prefix portion of the natural language query and the suffix speech recognition result for the suffix portion of the natural language query to generate the second response solicited by the natural language query spoken by the user.

20. The system of claim 19, wherein the operations further comprise increasing a duration of the EOU duration threshold based on receiving the suffix audio stream characterizing the suffix portion of the natural language query.
